(19) United States
(12) Patent Application Publication
(10) Pub. No.: US 2005/0067557 A1
(43) Pub. Date: Mar. 31, 2005

(54) Photoelectric controller and demonstrating apparatus simulating real life traffic means built in the photoelectric controller

(76) Inventor: Edward Wong, Kowloon (HK)

Correspondence Address: RABIN & BERDO, P.C.;Suite 500, 1101 14th Street, Washington, DC, 20005, US

(21) Appl. No.: 10/671,562

(22) Filed: Sep. 29, 2003

(51) Int. Cl. G06M 7/00

(52) U.S. Cl. 250/221

(57) ABSTRACT

The present invention discloses a photoelectric controller and demonstrating apparatus simulating a real life traffic means built in the photoelectric controller to make the demonstrating apparatus give lights and/or play sounds upon detecting a signal. The controller includes a sensing, preamplifier, amplifier, processing control, sound actuating units, etc. When a person approaches the apparatus within a certain range, the sensing unit detects the signal emitted from the human body and sends it to the preamplifier, processing control units, and drives the speaker to play various sounds simulating real circumstances via the sound actuating unit. Thus, the demonstrating apparatus with photoelectric controller the present invention can simulate a real life means, such as a traffic-lights system, a road sign, a parking meter, a railroad crossing, and a gas pump.

### FIELD OF INVENTION

The present invention relates to a photoelectric controller of a demonstrating apparatus, more specifically, relates to a photoelectric controller installed in a demonstrating apparatus simulating a real life means, e.g., a traffic-lights system, road signs, a parking meter, a railroad crossing, and a gas pump.

### BACKGROUND OF THE INVENTION

Living in modern society, some means have already become a part of our lives. For example, we see traffic lights when crossing an intersection; we see road signs in various areas; we see railroad crossing when passing a railway. For one who drives a car, he/she often deals with a parking meter and/or a gas pump.

When the above means bring us safety and convenience, we also know that only everyone follows certain rules, can the above means really benefit our lives.

For instance, it is important to have everyone, particularly children, to-observe traffic regulations, as this has a bearing on everyone's safety and is also a duty of the whole society. When one crosses an intersection, he/she has to look at the traffic lights, i.e., look around, slow down and then cross, stop when it shows a red light and cross when it turns to a green light. Further, when one sees a road sign, he/she has to respond accordingly with respect to different indications. If a road sign is set up in a school area, one needs to slow down the speed and not to blow the horn. If a road sign is set up in a no-entry area, one needs to stop entering such area. If a road sign is set up in a no-parking area, one needs to drive the car away and not to park in such area. In addition, when one crosses a railroad, he/she has to look at the railroad crossing first, i.e., make sure to look around, slow down, and then cross. The above traffic rules may sound simple, but it is not easy for everyone to keep in real life. Not so many people can say that he/she has never violated such rules. Thus, it is important to form a good habit of observing traffic regulations from childhood. For children to learn traffic laws and regulations, it is also necessary to provide an apparatus that fits the features of their age, so as to make the learning more enjoyable.

Further, it is necessary for one to learn some basic skills in modern society, such as operating a parking meter or a gas pump.

Up to now, no such demonstrating apparatus is available that has a photoelectric controller to provide indication light and/or sounds upon detecting a signal (e.g., a body motion), so as to simulate a real life means, i.e., a traffic-lights system, road signs, a parking meter, a railroad crossing, and a gas pump. Particularly, no such demonstrating apparatus is available that adapts to the features of children and makes the learning more enjoyable for them.

### SUMMARY OF THE INVENTION

The present invention provides a photoelectric controller installed in a demonstrating apparatus to make the demonstrating apparatus give lights and/or play sounds upon detecting a signal (e.g., a body motion). The demonstrating apparatus can simulate a real life means, such as a traffic-lights system, road signs, a parking meter, a railroad crossing, and a gas pump.

The photoelectric controller of the present invention includes a sensing unit for detecting a body motion, a preamplifier unit, an amplifier unit, a frequency discrimination amplifier unit, a processing control unit, a sound actuating unit, a speaker, and a language mode interchanging unit.

The sensing unit detects a signal emitted from human body and sends the signal to the preamplifier unit.

The preamplifier unit amplifies the signal received from the sensing unit, and sends the preliminarily amplified signal to the amplifier unit.

The amplifier unit performs secondary amplification and sends the amplified signal to the frequency discrimination amplifier unit.

The frequency discrimination amplifier unit further amplifies the signal from the amplifier unit, performs phase discrimination, and sends the signal to the processing control unit.

The processing control unit processes the signal from the frequency discrimination amplifier-unit, and sends a processed signal to the sound actuating unit.

When the sound actuating unit receives the signal from the processing control unit, it actuates the speaker.

The language model interchanging unit contains a wave-band interchanging switch. One end of the switch connects to a power supply, and the other end of the switch may have a plurality of terminals each of which connects to the processing control unit.

The sensing unit used for detecting the body motion is a thermoelectric detector.

A filter is provided between the preamplifier unit and the sensing unit, and a “Π” type filter is provided between the input and output of the preamplifier unit. The preamplifier unit and the amplifier unit are both operational amplifiers.

The photoelectric controller further includes an inductive indicator, which is placed between the processing control unit and the ground.

The processing control unit has built-in programs for controlling language interchanging and sound simulating.

The photoelectric controller can be used in a demonstrating apparatus.

In one embodiment, the photoelectric controller is placed in a demonstrating apparatus that simulates a traffic-lights system. The demonstrating apparatus further includes a lamp case having three indicator lights, i.e., a red light, a yellow light and a green light. The photoelectric controller is installed in the lamp case. The demonstrating apparatus further includes an indicator-lights driving unit having three branch circuits, which controls the three indicator lights, i.e., the red light, the yellow light and the green light, respectively. The indicator-lights driving unit connects to the processing control unit of the photoelectric controller to receive the output signal, so as to control the three indicator lights to work alternately. It is noted that the sensing unit of the photoelectric controller is mounted on the front of the lamp case. The lamp case is mounted on a support pole with a base there under.

In a second embodiment, the photoelectric controller is placed in a demonstrating apparatus that simulates a road sign. The demonstrating apparatus further includes a signboard, a bracket for holding the signboard, and a stand for supporting the bracket with a base there under. The photoelectric controller is installed in the bracket. The demonstrating apparatus may further have a plurality of operation switches corresponding to various road signs. The operation switches connect to the processing control unit of the photoelectric controller.

In a third embodiment, the photoelectric controller is placed in a demonstrating apparatus that simulates a parking meter. The demonstrating apparatus further includes a meter head and a stand for supporting the meter head with a base there under. The meter head has an operation panel, a time indication light, and coin dropping/card inserting slots. The photoelectric controller is installed in the meter head. The demonstrating apparatus further includes a time & fee control unit and a time & payment method display unit. The time & fee control unit confirms parking time and payment method, and is connected between a power supply and the processing control unit of the photoelectric controller. The time & payment method display unit indicates parking time and payment method, and is connected between the processing control unit of the photoelectric controller and the earth.

In a fourth embodiment, the photoelectric controller is placed in a demonstrating apparatus that simulates a railroad crossing. The demonstrating apparatus further includes a crossing bar having a lift arm, a case, and a stand for supporting the lift arm and the case. The photoelectric controller is installed in the case. The demonstrating apparatus further includes a lift arm actuating unit and a motor. The lift arm actuating unit connects to the processing control unit of the photoelectric controller to receive the output signal, so as to actuate the motor to raise/drop the lift arm. The lift arm actuating unit contains an arm raising actuating branch and an arm dropping actuating branch. The arm raising actuating branch actuates the motor to rotate clockwise, and the arm dropping actuating branch actuates the motor to rotate counterclockwise. Furthermore, the demonstrating apparatus includes an alarm-lights actuating unit and two alarm lights. The alarm-lights actuating unit connects to the processing control unit of the photoelectric controller, and has two actuating branches to respectively actuate the two alarm lights, so as to control them to turn on alternately. In addition, the demonstrating apparatus has a cross-shaped signboard mounted on the stand.

In a fifth embodiment, the photoelectric controller is placed in a demonstrating apparatus that simulates a gas pump. The demonstrating apparatus further includes a control box with a control panel therein, and an oil gun connected to the control box via a flow line. The photoelectric controller is installed in the control box. The demonstrating apparatus further includes an oil grade control unit, a payment control unit and a confirmation unit. The oil grade control unit confirms the oil grade, the payment control unit confirms the payment amount, and the confirmation unit confirms money transaction. The oil grade control unit, the payment control unit, and the confirmation unit are all connected between the processing control unit of the photoelectric controller and a power supply.

Thus, with the photoelectric controller of the present invention installed in the various demonstrating apparatus as discussed above, the demonstrating apparatus can simulate a traffic-lights system, road signs, a parking meter, a railroad crossing, and a gas pump.

### BRIEF DESCRIPTION OF DRAWINGS

FIG. 1 is a block diagram showing a photoelectric controller according to the present invention.

FIG. 2 is a schematic: view of a demonstrating apparatus having the photoelectric controller simulating a traffic-lights system according to one embodiment of the present invention.

FIG. 3 is a block diagram showing operational principle of the demonstrating apparatus of FIG. 2.

FIG. 4 is a schematic view showing electrical principle of the demonstrating apparatus of FIG. 2.

FIG. 5 is a schematic view of a demonstrating apparatus having the photoelectric controller simulating a road sign according to one embodiment of the present invention.

FIG. 6 is a block diagram showing operational principle of the demonstrating apparatus of FIG. 5.

FIG. 7 is a schematic view showing electrical principle of the demonstrating apparatus of FIG. 5.

FIG. 8 is a schematic view of a demonstrating apparatus having the photoelectric controller simulating a parking meter according to one embodiment of the present invention.

FIG. 9 is a block diagram showing operational principle of the demonstrating apparatus of FIG. 8.

FIG. 10 is a schematic view showing electrical principle of the demonstrating apparatus of FIG. 8.

FIG. 11 is schematic view of a demonstrating apparatus having the photoelectric controller simulating a railroad crossing according to one embodiment of the present invention.

FIG. 12 is a block diagram showing operational principle of the demonstrating apparatus of FIG. 11.

FIG. 13 is a schematic view showing electrical principle of the demonstrating apparatus of FIG. 11.

FIG. 14 is a schematic view of a demonstrating apparatus having the photoelectric controller simulating a gas pump according to one embodiment of the present invention.

FIG. 15 is a block diagram showing operational principle of the demonstrating apparatus of FIG. 14.

FIG. 16 is a schematic view showing electrical principle of the demonstrating apparatus of FIG. 14.

### DETAILED DESCRIPTION OF PREFERRED EMBODIMENT

The present invention provides a photoelectric controller installed in a demonstrating apparatus, so that the demonstrating apparatus can give lights and/or play sounds upon detecting a signal. The demonstrating apparatus can simulate a real life means, such as a traffic-lights system, a road sign, a parking meter, a railroad crossing, and a gas pump, to remind people to observe the traffic regulations or to instruct people to operate a device.

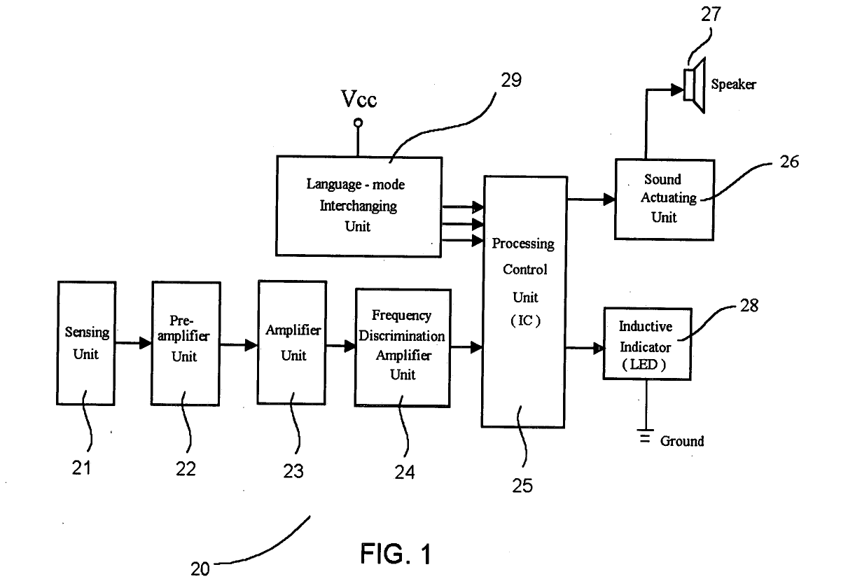

Referring now to FIG. 1, the photoelectric controller 20 of the present invention includes a sensing unit 21, a preamplifier unit 22, an amplifier unit 23, a frequency discrimination amplifier unit 24, a processing control unit 25, a sound actuating unit 26, a speaker 27, an inductive indicator 28, and a language-mode interchanging unit 29.

The sensing unit 21 detects a signal of a body motion and sends the signal to the preamplifier unit 22. The preamplifier unit 22 performs primary amplification and sends the primary amplified signal to the amplifier unit 23. The amplifier unit 23 performs secondary amplification and sends the amplified signal to the frequency discrimination amplifier unit 24. The frequency discrimination amplifier unit 24 further amplifies the signal from the amplifier unit 23, performs phase discrimination, and sends the signal to the processing control unit 25. The processing control unit 25 processes the signal from the frequency discrimination amplifier unit 24, and sends the processed signal to the sound actuating unit 26 to actuate the speaker 27. The inductive indicator, 28 is connected between the processing control unit 25 and the ground. The language-mode interchanging unit 29 contains a wave-band interchanging switch. One end of the switch connects to a power supply, and the other end of the switch connects to the processing control unit.

The sensing unit 21 for detecting the body motion is a thermoelectric detector.

A filter (not shown in FIG. 1) is provided between the preamplifier unit 22 and the sensing unit 21, and a ‘π’-type filter (not shown in FIG. 1) is provided between the input and output of the preamplifier unit 22. The preamplifier unit 22 and the amplifier unit 23 are both operational amplifiers.

The photoelectric controller 20 can be used in various demonstrating apparatus, so as to allow the demonstrating apparatus to give lights and/or play sounds upon detecting a signal (e.g., a body motion) via the sensing unit 21. For example, the photoelectric controller 20 can be installed in a demonstrating apparatus for simulating a real life means, e.g., a traffic-lights system, road signs, a parking meter, a railroad crossing, and a gas pump. Thus, the demonstrating apparatus with the photoelectric controller therein can remind people to observe the traffic regulations or to instruct people to operate a device.

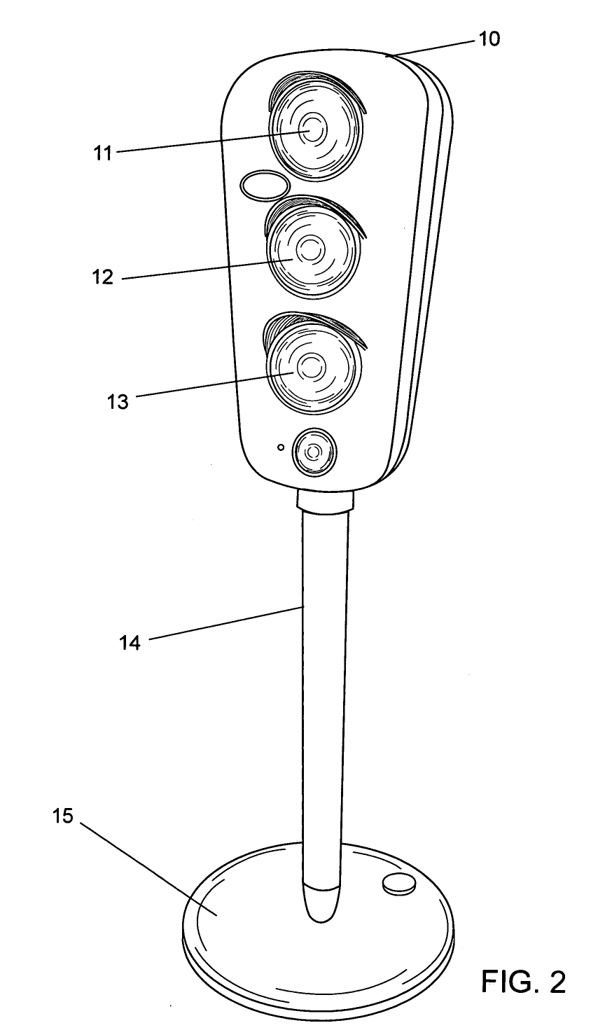

FIGS. 2-16 are provided to illustrate five embodiments using the photoelectric controller of the present invention. Detailed description will be given to the five embodiments with respect to five demonstrating apparatus using the photoelectric controller.

### Embodiment 1

Referring to FIG. 2, the photoelectric controller of the present invention is provided in a demonstrating apparatus that simulates a traffic-lights system. The demonstrating apparatus includes a lamp case 10 having a shape similar to that of the real life traffic lights with three indicator-lights (i.e., a red light 11, a yellow light 12 and a green light 13) mounted therein. The lamp case 10 is mounted onto a support pole 14 which is connected to a base 15 like a container shape, so the base 15 can be weighted with sand or water. The photoelectric controller 20 (not shown in FIG. 2) is mounted in the lamp case 10. The demonstrating apparatus of FIG. 2 further includes an indicator-lights driving unit 166 having three branch circuits, which controls the three indicator lights, i.e., the red light, the yellow light and the green light, respectively (not shown in FIG. 2).

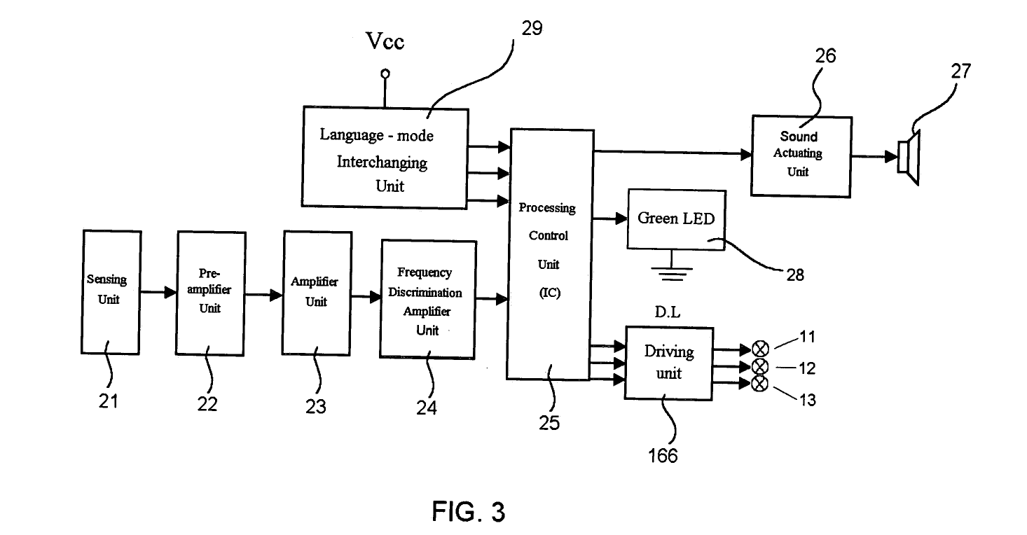

Now referring to FIG.3, the indicator-lights driving unit 166 is connected to one end of the processing control unit 25, so as to receive a signal from the processing control, unit 25 to control the three indicator lights (i.e., red, yellow, and green) to turn on alternately.

The processing control unit 25 may have built-in programs for controlling the three indicator-lights to turn on alternately, the language mode interchanging and the sound simulating.

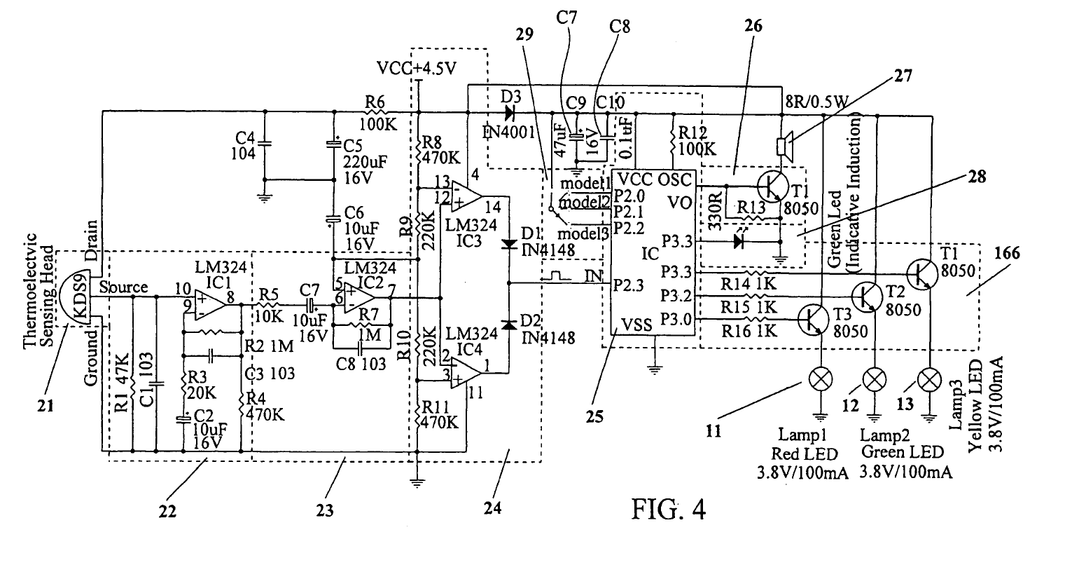

In the following, the demonstrating apparatus simulating a traffic-lights system will be further described with reference to the particular electric circuit shown in FIG.4.

In FIG. 4, the sensing unit 21 is a KDS9 type thermoelectric detector. The output of the sensing element 21 connects to the input of the preamplifier unit 22. The preamplifier unit 22 is an operational amplifier, in which R1, C1 form a filter, and C3, C2, and R4 form a “Π’-type filter. The output of the preamplifier unit 22 connects to the input of the amplifier unit 23. The amplifier unit 23 is also an operational amplifier, which has an output connecting to the input of the frequency discrimination amplifier unit 24. The frequency discrimination amplifier unit 24 has two operational amplifiers and two diodes, and the output of the frequency discrimination unit 24 is connected to the input of the processing control unit 25. The preamplifier unit 22, the amplifier unit 23 and the frequency discrimination amplifier unit 24 can share a LM324 type four-operational amplifier. The language mode interchanging unit 29 has a wave band interchanging switch. The processing control unit 25 is a special integrated block IC, in which terminals P2.0, P2.1, P2.2 are connected to the wave band interchanging switch respectively, terminals VCC, OSC connect to the positive pole of the power supply via diode D3, and terminal VSS is earthed. Terminals P3.0, P3.1, P3.2 are connected respectively to the three branch circuits of the indicator-lights driving unit 166. The three branch circuits use triodes T1, T2, T3 for driving operation, in which each emitter of the triodes (T1, T2, T3) is connected to one indicator-light, i.e., the red light, the yellow light or the green light. Terminal VO is connected to the sound actuating unit 26, which has a triode T4. The speaker 27 is connected between the collector of triode T4 and the diode D3. Terminal P3.3 is connected to the inductive indicator 28.

When a person approaches the demonstrating apparatus within a certain range (usually the distance is set to about 3 meters, and viewing angle is set to 130°), the thermo-electric detector 21 detects the infrared rays emitted from human body, and sends a pulse signal to the preamplifier unit 22 to be pre-amplified. The pre-amplified signal is then sent to the amplifier unit 23 to be further amplified. The output signal is then sent to the frequency discrimination amplifier unit 24 to be further amplified and be phase discriminated to form a consecutive positive pulse signal which is sent to terminal P2.3 of the integrated block IC. After the integrated block IC 25 processes the signal, the processed signal is then sent to the indicator-light driving unit 166. The driving unit 166 controls the red indicator-light 11, the yellow indicator-light 12 and the green indicator-light 13 to make them turn on alternately. The processed signal is also sent to the sound actuating unit 26 to actuate the speaker 27.

In the demonstrating apparatus that simulates a traffic-lights system, the integrated block IC 25 of the photoelectric controller can play three modes of language:
Mode 1 is English;
Mode 2 is French;
Mode 3 is Spanish.

Mode 1, mode 2, mode 3 can be interchanged at any time.

When the wave band interchanging switch is switched to one mode (mode 1, mode 2 or mode 3), the speaker makes the sound “beep-beep”. After the sound “beep-beep”, traffic light starts to show in an order of “red-green-yellow” alternately:
3.1) Red light turns on for approx 5 seconds
3.2) Green light turns on for approx 6 seconds
3.3) Yellow light turns on for approx 3 seconds

The red light 11, the green light 13, and the yellow light 12 work alternately, i.e., when one light is off, another light must be on.

If no signal has been detected for 1 minute, IC will go to ‘sleep mode’ automatically. It can be re-activated by switching on the power.

When IC block 25 has been powered on for 10 seconds, the inductive indicator (green LED) 28 will turn on (If the sensing unit 21 does not detect any signal or the speaker 27 does not play sound, this green LED will be on. If no signal has been detected for 1 minute, IC will go back to ‘sleep mode’).

In mode 1 (English mode), after the inductive indicator (green LED) turns on, if someone approaches the detectable area and thus triggers IC, the following sound will be played. (the green LED will be off after the IC has been triggered, and will be on again after the following sound ends, to indicate that IC is waiting for triggering).

When red light is on, the following phrases will be played:
(a) The light is red, “please stop!”→braking sound→engine idle sound.
(b) “red means stop, green means go!”→braking sounds→engine idle sound.

The above sentences (a) and (b) will be played alternately with one for each time.

When green light is on, the following phrases will be played:
(a) “green light! Let's go”→acceleration sound.
(b) “Watch for cars and look both ways! We want you safe for all your days”→acceleration sound.

The above sentences (a) and (b) will be played alternately with one for each time.

When yellow light is on, the following phrases will be played:
(a) “Intersection ahead, proceed with caution”→various traffic sounds
(b) “Drive safe! No speeding!”→various traffic sounds.

The above sentences (a) and (b) will be played alternately with one for each time.

When the above sounds end, the program automatically goes to steps 3.1-3.3. If no signal has been detected for one minute, IC will go to the ‘sleep mode’ automatically, and it can be re-activated by switching on the power.

In mode 2 (French mode), after the inductive indicator (green LED) 28 turns on, if someone approaches the detectable area and thus triggers IC, the following sound will be played. (the green LED will be off after the IC has been triggered, and will be on again after the following sound ends, to indicate that IC is waiting for triggering).

When red light is on, the following phrases will be played:
(a) Le feu est rouge. Arrête-toi.→braking sound→engine idle sound.
(b) Rouge signifie “arrêt”.vert signifie “Repartir”→braking sound→engine idle sound.

The above sentences (a) and (b) will be played alternately with one for each time.

When green light is on, the following phrases will be played:
(a) Feu vest! Repars!→accelerating sound.
(b) Attention aux voitures et regarde des deux côtés! Nous te voulons sain et sauf pendant toute ta vie!→accelerating sound.

The above sentences (a) and (b) will be played alternately with one for each time.

When yellow light is on, the following phrases will be played:
(a) Attention au carrefour, rouledoucement→various traffic sounds.
(b) Regarde des deux côtés et ne prends pas de risques→various traffic sounds.

The above sentences (a) and (b) will be played alternately with one for each time.

When the above sounds end, the program automatically goes to steps 3.1-3.3. If no signal has been detected for one minute, IC will go, to the ‘sleep mode’ automatically, and it can be re-activated by switching on-the power.

In mode 3 (Spanish mode), after the inductive indicator (green LED) 28 turns on, if someone approaches the detectable area and thus triggers IC, the following sound will be played. (the green LED will be off after the IC has been triggered, and will be on again after the following sound ends, to indicate that IC is waiting for triggering).

When red light is on, the following phrases will be played:
(a) El semáforo estárojo.i Espera!→braking sound→engine idle sound.
(b) i Rojo significa parar, Verde significa Adelante→braking sound→engine idle sound.

The above sentences (a) and (b) will be played alternately with one for each time.

When green light is on, the following phrases will be played:
(a) i Semáforo Verde! I Vamos→accelerating sound.
(b) i Cuidado con los coches y mira a los dos lads! I Queremos que estes a salvo, TODOS los dias!→accelerating sound.

The above sentences (a) and (b) will be played alternately with one for each time.

When yellow light is on, the following phrases will be played:
(a) i Hay un cruce delante, sigue con precaución!→various traffic sounds.
(b) Mira a los dos lados y ten cuidado→various traffic sounds.

The above sentences (a) and (b) will be played alternately with one for each time.

When the above sounds end, the program automatically goes to steps 3.1-3.3. If no signal has been detected for one minute, IC will go to the ‘sleep mode’ automatically, and it can be re-activated by switching on the power.

The interval between the above phrases is approximately one second.

### Embodiment 2

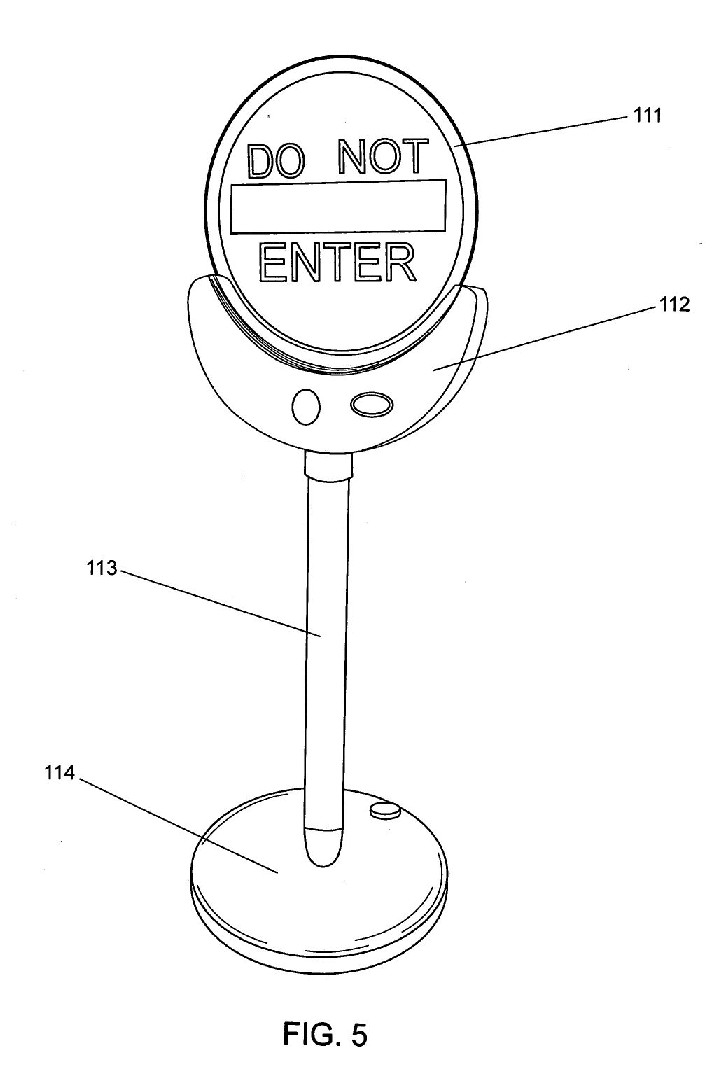

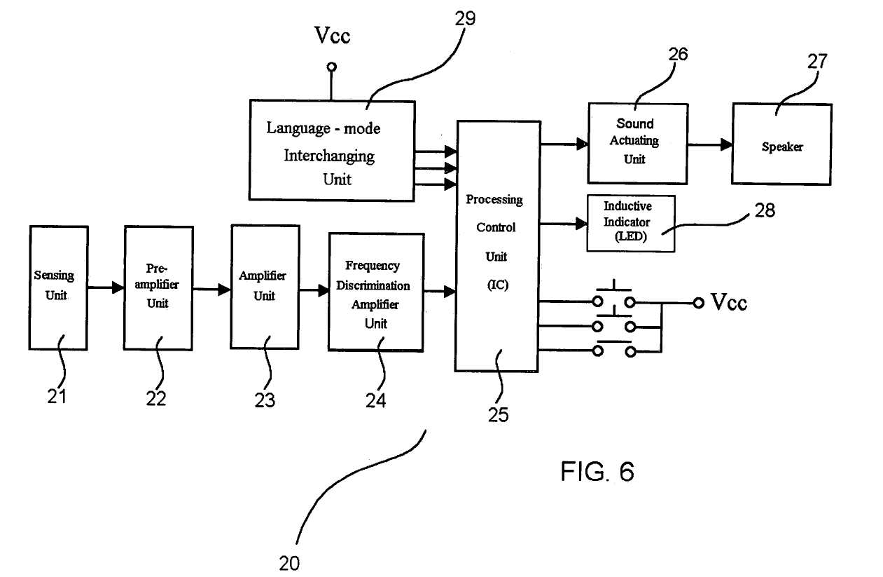

Referring to FIG. 5 and FIG. 6. The photoelectric controller of the present invention is provided in a demonstrating apparatus that simulates a road sign. The demonstrating apparatus includes a plurality of signboards 111, a bracket 112, a stand 113 and a base 114 that can be weighted with sand or water. One of the signboards 111 is mounted onto the bracket 112 and can be exchanged by children-self, the stand 113 supports the bracket 112, and the photoelectric controller 20 is mounted in the bracket 112. The bracket 112 is about 1 meter high.

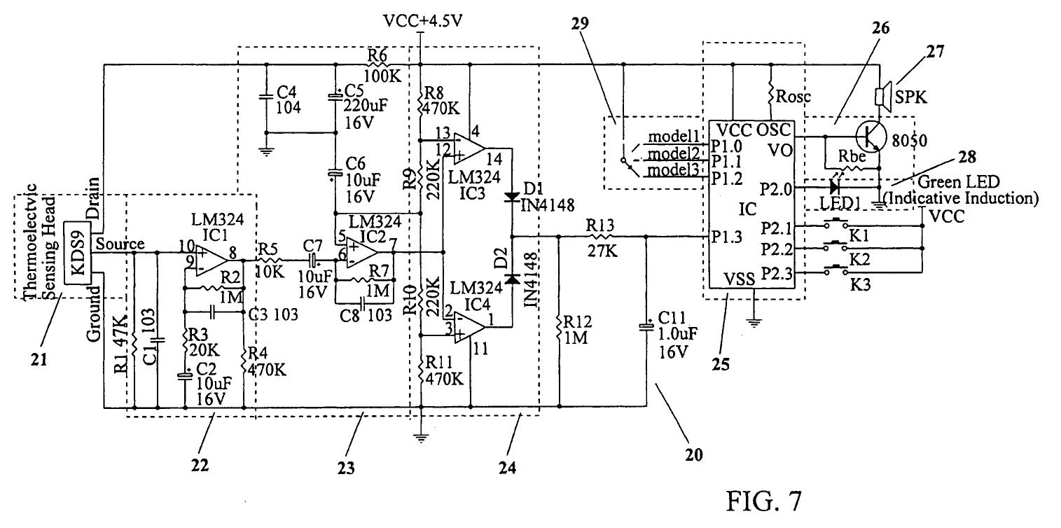

The demonstrating apparatus further has a plurality of operation switches (e.g., three switches as shown in FIGS. 6 and 7) corresponding to different road signs, which are connected to an end of the processing control unit 25.

The processing control unit 25 may-have built-in programs for controlling language mode interchanging and sound simulating.

In the following, the demonstrating apparatus simulating a road sign will be further described with reference to the electric circuit shown in FIG. 7. In the FIG. 7, the light sensing unit 21 is a KDS9 type thermoelectric detector, and the output of the sensing unit 21 connects to the input of the preamplifier unit 22. The preamplifier unit 22 is an operational amplifier, in which R1, C1 form a filter, and C3, C2, R4 form a “Π” type filter. The output of the preamplifier unit 22 is connected to the input of the amplifier unit 23. The amplifier unit 23 is also an operational amplifier. The output of the amplifier unit 23 is connected to the input of the frequency discrimination amplifier unit 24. The frequency discrimination amplifier unit 24 adopts 2 operational amplifiers and 2 diodes, and the output of the frequency discrimination amplifier unit 24 is connected to the input of the processing control unit 25. The preamplifier unit 22, the amplifier unit 23, and the frequency discrimination amplifier unit 24 can share a LM324 type 4-operational amplifier. The processing control unit 25 is a special integrated circuit block IC. The language-mode interchanging unit 29 adopts a 3 wave-band switch corresponding to the 3 language modes. Terminals P1.0, P1.1, P1.2 of the integrated circuit block IC are connected to the 3-wave-band switch respectively. K1, K2, K3 are operation switches. K1 corresponds to a “stop” sign, K2 corresponds to a “do not enter” sign, and K3 corresponds to a “playground” sign. K1, K2, K3 are respectively connected to the terminals P2.1, P2.2, P2.3 of the processing control unit 25. Terminal P1.3 is an input terminal, which receives the signal from the frequency discrimination amplifier unit 24. VCC, OSC are connected to the positive pole of a power supply via resistors, and VSS is connected to the ground (earth). Terminal Vo is connected to the input end of the sound actuating unit 26. The sound actuating unit 26 has a triode T1, and the speaker 27 is placed between the collector of the triode T1 and the power supply Vcc. Terminal 2.0 is connected to the inductive 25 indicator 28, which has a green LED.

When a person approaches the demonstrating apparatus within a certain range (usually the distance is set to about 3 meters with a viewing angle of 130°), the thermoelectric detector (the sensing unit) detects the infrared rays from the human body, and sends a pulse signal to the preamplifier unit for pre-amplification. After pre-amplification, the signal will be amplified again by the amplifier unit, and the amplified signal will be sent to the-frequency discrimination amplifier unit for further amplification and phase discrimination, so as to form a consecutive positive pulse signal. The pulse signal will then be sent to the terminal P1.3 of the integrated circuit block IC for processing.

The photoelectric controller actuates the speaker to play various sounds via the sound actuating unit, to remind people that they have arrived the corresponding areas.

The integrated circuit block IC of the photoelectric controller may have built-in programs for controlling language mode interchanging, language processing, and sound simulating.

The integrated circuit block IC has the following three operation modes:
Mode 1 is English
Mode 2 is French
Mode 3 is Spanish

The above three modes can be interchanged at any time.

When the wave band switch is switched to Mode 1, Mode 2 or Mode 3, a card-swiping sound is played. After the integrated circuit block IC has been powered on for approx ten seconds, the inductive indicator 28 (green LED) will turn on.

When the wave-band switch switches to Mode 1 (English mode), a card-swiping sound is played.
When switch K1 is closed (which represents ‘stop’ sign), a card-swiping sound is played. If a person walks into the detectable area when the green LED is on (the green LED will then turn off after detecting the signal), the following sounds will be played alternately:
(a) ‘honk-honk’ sound→stop sign ahead! Slow down and prepare to stop;
(b) ‘honk-honk’ sound→Make sure you come to a complete stop;
(c) ‘honk-honk’ sound→Stop and look both ways!;
(d) ‘honk-honk’ sound→Follow the signs when you play, to make sure you are safe all day!

When switch K2 is closed (which represents “Do Not Enter” sign), a card-swiping sound is played. If a person walks into the detectable area when the green LED is on (the green LED will then turn off after detecting the signal), the following sounds will be played alternately:
(a) “Oh! Oh” sound→Danger! Do not enter!
(b) “Oh! Oh” sound→Traffic approaching ahead! Wrong Way!
(c) “Oh! Oh” sound→Construction area ahead! Do not enter!
(d) “Oh! Oh” sound→Follow the signs when you play, to make sure you are safe all day!

When switch K3 is. closed (which-represents “Playground” sign), a card-swiping sound is played. If a person walks into the detectable area when the green LED is on (the green LED will then turn off after detecting the signal), the following sounds will be played alternately:
(a) “Slow down, playground ahead!→laughing sound;
(b) “Drive carefully, children are playing”→laughing sound;
(c) “Slow down and be safe, children crossing!”→laughing sound;
(d) “Follow the signs when you play, to make sure you are safe all day.”→laughing sound.

If no one-walks into the detectable area for one minute, IC will go to ‘sleep mode’, and the sound will go off. IC can be re-activated by switching on power.

When the wave-band switch switches to Mode 2 (French mode), a card-swiping sound is played.

When switch K1 is closed (which represents “stop” sign), a card-swiping sound is played. If a person walks into the detectable area when the green LED is on (the green LED will then turn off after detecting the signal), the following sounds will be played alternately:
(a) ‘honk-honk’ sound→“Attention au panneau, “arrêt”! Ralentis et apprête-toi à tárrêter!;
(b) ‘honk-honk’ sound→Assure toi que tu es bien à l'arrêt complet!
(c) ‘honk-honk’ sound→arête-toi etregarde des dewx eôtés!
(d) ‘honk-honk’ sound→observe bien les panneaux quand tu jòues powr t'assurer que tu ne cours jamais de danger.

When switch K2 is closed (which represents “Do not enter” sign), a card-swiping sound is played. If a person walks into the detectable area when the green LED is on (the green LED will then turn off after detecting the signal), the following sounds will be played:
(a) “Oh,Oh” sound→Danger! N'entre pas!
(b) “Oh,Oh” sound→la circulation vient vers toi! Mauvais sens!
(c) “Oh,Oh” sound→Chantiér de construction un peu plus loin! N'entre pas!
(d) “Oh,Oh” sound→Observe bien les panneaux quand tu joues powr t'assurer que tu necours jamais de danger.

When switch K3 is closed (which represents “playground” sign), a card-swiping sound is played. If a person walks into the detectable area when the green LED is on (the green LED will turn off after detecting the signal), the following sounds will be played:
(a) Ralentis parc à jeux un peu plus loin!→laughing sound;
(b) Conduis prudemment, des enfants sont en train de jouer!→laughing sound
(c) Ralentis et sois prudent, des enfants traversent.→laughing sound
(d) Observe bien les panneaux quand tu joues tu joues pour t'assurer que tu ne cours jamais de danger.→laughing sound

When the wave-band switch switches to Mode 3 (Spanish mode), a card-swiping sound is played.

When switch K1 is closed (which represents “stop” sign), a card-swiping sound is played. If a person walks into the detectable area when the green LED is on (the green LED will then turn off after detecting the signal), the following sounds will be played:
(a) ‘honk-honk’ sound→Señal de stop delante! I Reduce la velocidad Y preparáte para parar!
(b) ‘honk-honk’ sound→I Asegúrate de para por complete!
(c) ‘honk-honk’ sound→I Para y mùra a. los dos lados!
(d) ‘honk-honk’ sound→I Respeta las senates cuando estás jugando para estar a salvo todo el día.

When switch K2 is closed (which represents “Do not enter” sign), a card-swiping sound is played. If a person walks into the detectable area when the green LED is on (the green LED will then turn off after detecting the signal), the following sounds will be played:
(a) “Oh,Oh”sound→ì peligro! Prohilida la entrada!
(b) “Oh,Oh”sound→ì Hay tráffico a continuación! I Ruta incorrecta!
(c) “Oh,Oh” sound→I Zona en Obras! I Prohibida la entrada!
(d) “Oh,Oh”sound→I Respela las señales cuando estás jugando, para estar a salvo todo el día!

When switch K3 is closed (which represents “playground” sign), a card-swiping sound is played. If a person walks into the detectable area when the green LED is on (the green LED will then turn off after detecting the signal), the following sounds will be played:
(a) ì Reduce la velociadad, povrque delante!→laughing sound;
(b) ì Conduce con precaución, hay niños jugando!→laughing sound;
(c) Reduce la velocidad y cuidado, hay niños cruzando!→laughing sound;
(d) ì Reopeta las sefiales cuando estás jugando, para estar a salvo todo el día!→laughing sound.

If no one walks into the detectable area for one minute, IC will go to ‘sleep mode’, and the sound will go off. IC can be re-activated by switching on the power.

It is understood that the above examples have been presented for the purposes of illustration only. For instance, other kinds of languages and different contents of phrases can also be used.

### Embodiment 3

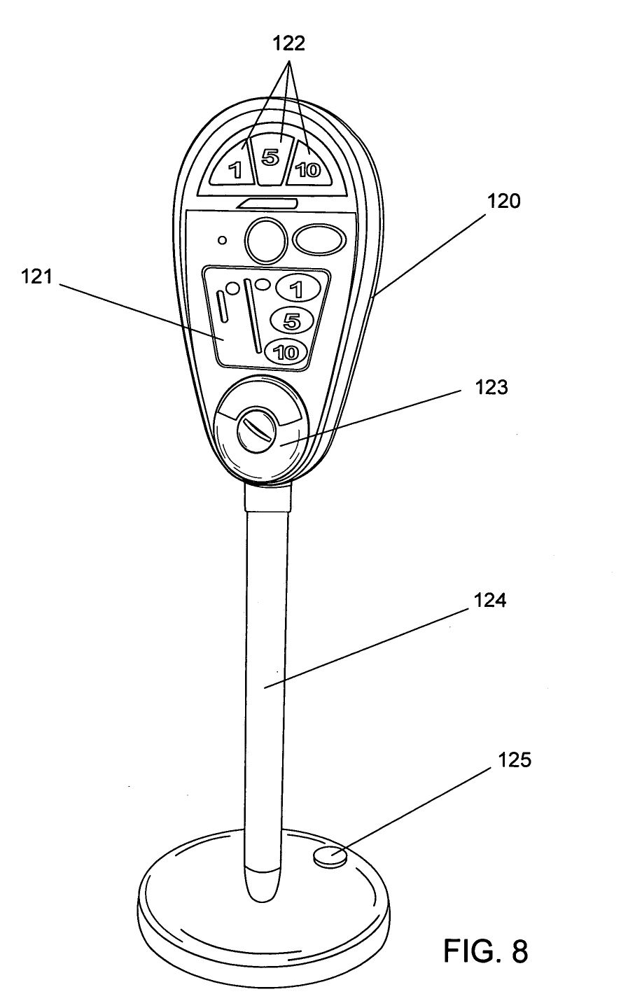

Referring to FIG. 8, the photoelectric controller of the present invention is provided in a demonstrating apparatus that simulates a parking meter. The demonstrating apparatus includes a meter head 120, and a stand 124. The meter head 120 has an operation panel 121, a time indication light 122, and coin dropping/card inserting slots 123. The meter head 120 ismounted onto the stand 124.

The photoelectric controller 20 is installed in the meter head (not shown in FIG. 8). The lower end of the stand 124 connects to a base 125 which is weighted with sand or water. The base 125 has a sand or water injection hole for easy installing and moving the apparatus.

The demonstrating apparatus further includes a time & fee control unit 30 and a time & payment-method display unit 31 (not shown in FIG. 8). The time & fee control unit 30 confirms parking time and payment method, and the time & payment method display unit 31 indicates parking time and payment method (cash or card).

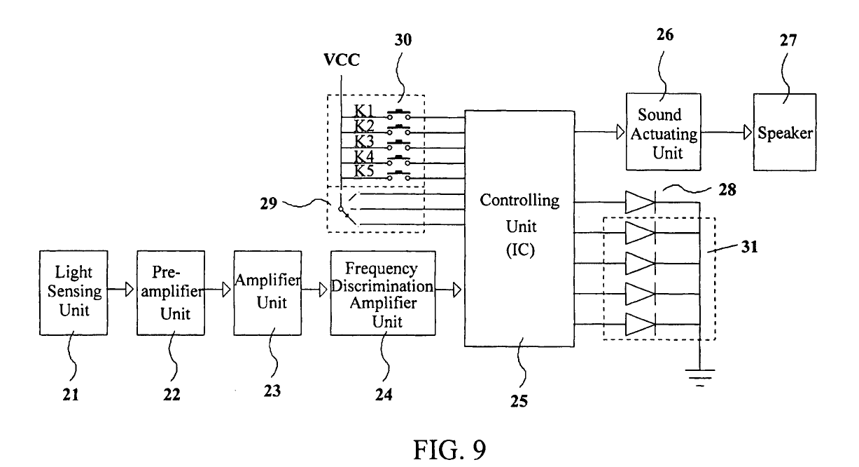

Now refer now to FIG. 9, the time & fee control unit 30 is connected between a power supply and the processing control unit 25. The time & payment control display unit 31 is connected between the processing control unit 25 and the earth.

The processing control unit 25 may have built-in programs used for language mode interchanging and sound simulating.

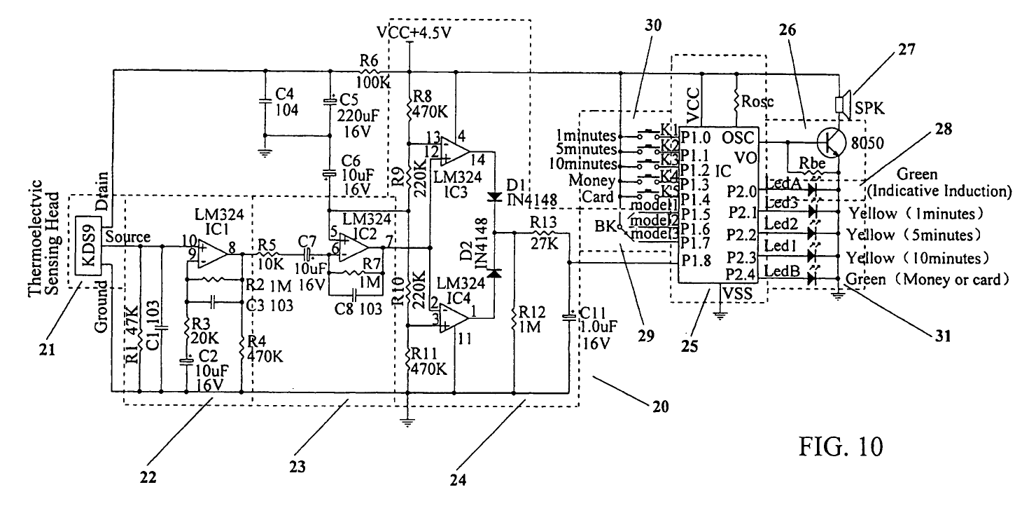

In the following, the demonstrating apparatus simulating a parking meter will be described further with reference to the electrical circuit shown in FIG. 10.

In FIG. 10, the sensing unit is a KDS9 type thermoelectric detector, the output of which is connected to the input of the preamplifier unit. The preamplifier unit is an operational amplifier, in which R1, C1 form a filter, and C3, C2, R4 form a “Π” type filter. The output of the preamplifier unit is connected to the input of the amplifier unit. The amplifier unit is an operational amplifier. The output of the amplifier unit is connected to the input of the frequency discrimination amplifier unit. The frequency discrimination amplifier unit adopts two operational amplifiers and two diodes. The output of the frequency discrimination amplifier unit is connected to the input of the processing control unit. The preamplifier unit, the amplifier unit, and the frequency discrimination amplifier unit can share a LM324 type four-operational amplifier. The language mode interchanging unit adopts a 3-wave-band switch. The processing control unit 25 is a special integrated circuit block IC, in which, three terminals P1.5, P1.6, P1.7 are connected to corresponding terminals of the wave band switch. Vcc, OSC are connected to the positive end of a power supply via a resistor, and Vss is earthed. The time & fee control unit is formed by switches K1, K2, K3, K4, K5. K1, K2, K3, K4, K5 are respectively connected to the terminals P1.0, P1.1, P1.2, P1.3, P1.4 of the-integrated circuit block IC. K1, K2, K3 are used to represent the parking time such as 1 minute, 5 minutes or 10 minutes, and K4, K5 are used to represent payment method such as cash or card. The time & payment method display unit is formed by four LEDs (light emitting diode). The positive poles of these-four diodes are respectively connected to terminals P2.1, P2.2, P2.3, P2.4 of the integrated circuit block IC, in which three diodes are used to display the parking time selected by the operator, and the fourth is used to display payment method. When a person approaches the demonstrating apparatus within a certain range (usually the distance is set to about 3 meters with a viewing angle of 130°), the thermoelectric detector detects the infrared rays emitted by the person and sends a pulse signal to the preamplifier unit. The preamplifier unit preliminarily amplifies the pulse signal and sends to the amplifier unit. The amplifier unit performs secondary amplification and sends the amplified signal to the frequency discrimination amplifier unit; The frequency discrimination amplifier unit further amplifies the signal and performs phase discrimination to form a continuous positive pulse which is then sent to terminal P1.8 of the integrated circuit block IC of the processing control unit. The processing control unit processes the signal and sends the processed signal to the sound actuating unit via terminal V0 of the IC to actuate the speaker. The integrated circuit block IC may have built-in programs for time counting, fee calculating, language mode interchanging and sound simulating.

The integrated circuit block IC has three operation modes:
Mode 1 is English mode
Mode 2 is French mode
Mode 3 is Spanish mode

The three modes can be interchanged at any time.

When the switch is turned to mode 1 or mode 2 or mode 3, a coin dropping sound is played. When the integrated circuit block IC has been powered on for ten seconds, the inductive indicator (green LED) turns on.

When the switch is turned to mode 1 (English mode), a coin dropping sound is played.
a) Approx 10 second after the coin dropping sound, the green LED A (inductive indicator) turns on, if any person walks into the detectable area, the following sound will be played “Nice parking spot”→“Kids parking only”→“Please select the amount of time!”
b) When pressing a button to select a time (10 or 5 or 1), corresponding yellow light (LED 1, LED 2 or LED 3) turns on and the following sound is played: “Please deposit a coin or insert your parking card”.

If no button is pressed, the sound of step a) will be played every 5 seconds for twice.

When the coin is dropped (deposited) or a parking card is inserted, the green LED B lights up for a second with a coin dropping or card inserting sound, and the following sound is played: “You have 1/5/10 minutes↓” →ticktack sound starts and time is counting down. (If no coin is deposited or no parking card is inserted, the sound of step b) will be played every 5 seconds for three times and then turns back to step a)).

When time is counting down to five minutes (if 10 minutes was selected), or time is counting down to the last minute (if 5 minutes was selected), corresponding reminder will be played: “You have 5 minutes” or “You have 1 minute”. (no reminder will be played if 1 minute was selected).

When time is counting down to 0, the following sound is played “Oh, Oh! Time has expired!→Please select a new time or move your vehicle”.

When the switch is turned to mode 2 (French mode), a coin dropping (deposit) sound is played.
c) 10 seconds after the coin dropping sound, the green LED A turns on, if any person walks into the detectable area, the following sound will be played: “Bel endroit de stationnement!”→stationnement pour enfants seulement!→S'il te plait, selectionne la durée du stationnement!”
d) When pressing a button to select a time (10 m or 5 m or 1 m), corresponding yellow light (LED1, LED2, or LED3) turns on and the following sound is played: “Thank you!”→“Insére donc une piece de monnaie out a carte de stationnement!”

If no button is pressed, the sound of step c) will be played every 5 seconds for twice.

When coin is deposited or the parking card is inserted, LED B will light up for a second with coin dropping or card inserting sound, and the following sound is played→tu as 1/5/10 minutes!→ticktack sound starts and time is counting down. (If no coin is deposited or no card is inserted, the sound step d) will be played every 5 seconds for three times and then turns back to step c)).

When time is counting down to five minutes (if 10-minute parking time was selected), or time is counting down to the last minute (if 5-minute parking time was selected), corresponding reminder will be played “Tu as 5 minutes” or “Tu as 1 minute” (no reminder will be played if one minute is selected).

When time is counting down to 0, the following sound is played “Oh là là durée de parking expirée!→choisis une mouvelle durée de parking ou deplace ton vehicule”, and turns back to step c) after the sound.

When the switch is turned to mode 3 (Spanish mode), a coin dropping sound is played.
e) 10 seconds after coin dropping sound, the green LED A turns on. If any person walks into the detectable area, the following sound is played: “ì Buen Sitio para aparear!”→ì Aparcamiento solo para nì os!”→selecciona el tiempo o mueve tu vehiculo!
f) When pressing a button to select a time (10 m or 5 m or 1 m), corresponding yellow light (LED 1, LED 2 or LED 3) turns on and the following sound is played “Deposita una moneda o introduce tu tarjeta de aparcamiento”.

If no button is pressed; the sound of step e) will be played every 5 seconds for twice.

When a coin is dropped or a card is inserted, green LED B lights up for a second with coin dropping or card inserting sound, as well as the following sound: “Dispones de 1/5/10 minutes!→ticktack sound starts and time is counting down (if no coin is dropped or no card is inserted, the sound of step f) will be played every 5 seconds for three times and then turns back to step e)).

When time is counting down to the last 5 minutes (when 10 minutes was selected) or to the last 1 minute (when 5 minutes was selected), corresponding reminder is played “Dispones de 5 minutes” or “Dispones de 1 minute!” (no reminder will be played when 1 minute was selected).

When time is counting down to 0, the following sound is played “Oh, Oh!” ì Tu tie mpo ha concluido!→ì seleccrona el timpo de Nuevo o nueve tu vehiculo!, and turns back to step f) after the sound.

It is understood that the language mode is not limited to the above-mentioned 3 modes and the above-mentioned 3 kinds of language. Various modes and languages can be designed according to different requirements.

### Embodiment 4

The photoelectric controller of the present invention is provided in a demonstrating apparatus that simulates a railroad crossing.

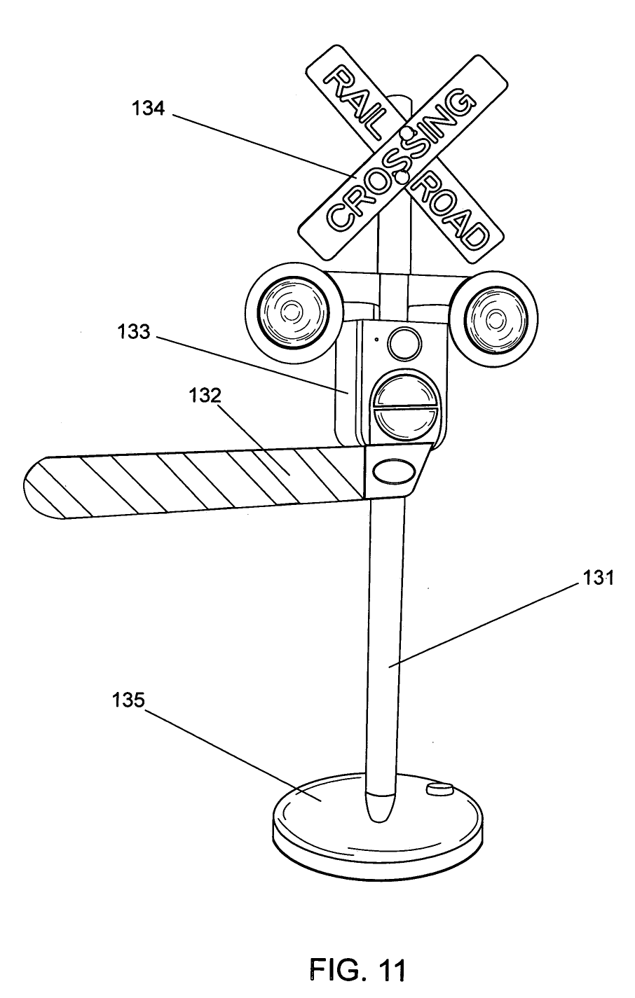

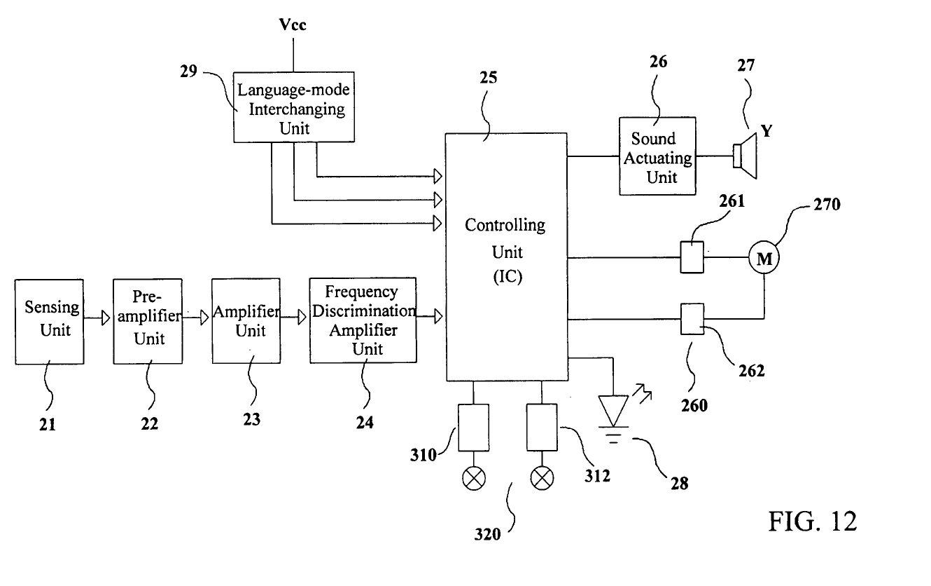

Referring to FIG. 11 and FIG. 12, the demonstrating apparatus has a crossing bar including a lift arm 132, a case 133, and a stand 131. The lift arm 132 and the case 133 are mounted on the stand 131. The photoelectric controller is installed in the case 133. The case 133 is positioned in the middle of the stand 131 (about 1 meter high). The lower end of the stand 131 connects to a base 135 which is weighted with sand or water.

The demonstrating apparatus further includes a lift arm actuating unit 260 and a motor. The lift arm actuating unit 260 connects to the processing control unit 25 to receive an 15 output signal, so as to actuate the motor 270 to lift up/drop down the lift arm 132. In this case, the lift arm 132 is pivotally imounted onto the rotation shaft of the motor 270. The lift arm actuating unit 260 contains an arm raising actuating branch 261 and an arm dropping actuating branch 262. The arm raising actuating branch 261 actuates the motor 270 to rotate clockwise, and the arm dropping actuating branch 262 actuates the motor 270 to rotate counterclockwise. Furthermore, the demonstrating apparatus has an alarm-lights actuating unit 310 and two alarm lights 320. The alarm-lights actuating unit 310 connects to the processing control unit 25, and has two actuating branches (311, 312) to respectively actuate the two alarm lights (red lights), so as to control them to turn on alternately, which indicates a train is passing. In addition, the demonstrating apparatus has a cross shaped signboard 134 mounted on the case 133, with characters “RAILROAD” and “CROSSING”, meaning railroad and crossing.

The processing control unit 25 may have built-in programs for controlling the alternate raising and dropping of the lift arm 132, language mode interchanging and sound simulating.

The sensing unit 21 for detecting a signal of a body motion is mounted on the front of the case 133.

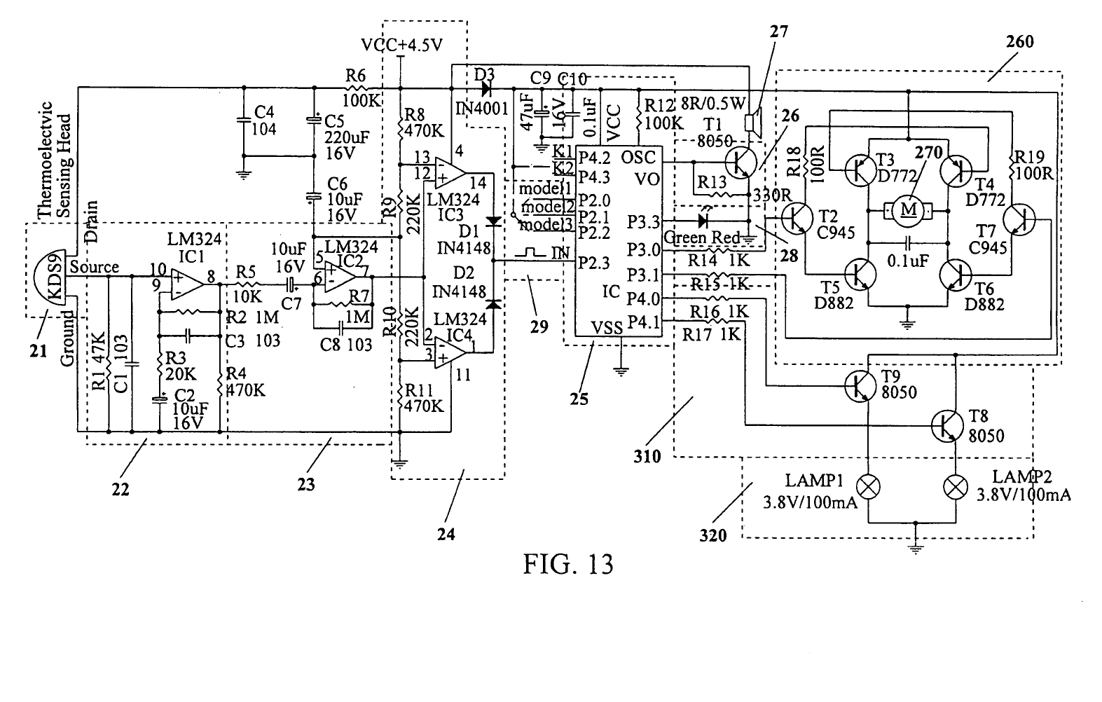

In the following, the demonstrating apparatus simulating a railroad crossing will be further described with reference to in FIG. 13. The sensing unit is a KDS9 thermoelectric detector, which has an output connecting to input of the preamplifier. The preamplifier adopts an operational amplifier in which R1, C1 form a filter, and C3, C2, R4 form a “Π” type filter. The output of the preamplifier is connected to the input of the amplifier. The amplifier unit also adopts an operational amplifier, which has an output connecting to the input of the frequency discrimination amplifier unit. The frequency discrimination amplifier unit has 2 operational amplifiers and two diodes. The output of the frequency discrimination amplifier unit is connected to the input of the processing control unit. The preamplifier unit, the amplifier unit and the frequency discrimination amplifier unit can share a LM324 type 4-operational amplifier. The processing control unit is a special integrated circuit block IC. The wave band interchanging switch adopts a 3-wave-band switch, corresponding to three language modes. Terminals P2.0, P2.1, P2.2 of the integrated circuit block IC are connected to the wave-band interchanging switch. K1 and K2 are operation switches which are connected to terminal P4.2, P4.3, respectively. Terminal P2.3 is an input terminal which receives the output signal from the frequency discrimination amplifier unit. Vcc, OSC are connected to the positive pole of the power supply via diode D3. Vss is earthed. Terminals P3.0, P3.1 are respectively connected to the input ends of the arm-raising actuating branch 261 and the arm-dropping actuating branch 262. These two actuating branches (261, 262) are formed by triodes T2-T7 (T2, T3, T4, T5, T6, and T7). When terminal P3.0 outputs a positive pulse, and terminal P3.1 outputs a negative pulse, triodes T2 and T5 are on state, and triodes T4, T6, T7 are cut off, the motor rotates clockwise to raise the lift arm 132. When terminal P3.0 outputs a negative pulse, and terminal P3.1 outputs a positive pulse, triodes T6, T7 are on state, and triodes T2, T3, T5 are cut off, the motor rotates counterclockwise to drop the lift arm 132. Terminal V0 is connected to the sound actuating unit 26 which is a triode T1. The speaker 27(Y) is placed between the collector of triode T1 and power supply Vcc. Terminal 3.3 is connected to the inductive indicator 28 which is a green LED. Terminals P4.0, P4.1 are connected to the two actuating branches 311, 312. Triodes T9, T8 are used to form the actuating branches 311, 312, respectively. The two alarm lights 320 are respectively placed between emitters of the triodes T9, T8 and the earth.

When a person approaches the demonstrating apparatus of the present invention within a certain range (usually the distance is set to about 3 meters with a viewing angle of 130°), the thermoelectric detector detects the infrared rays of the human body and sends a pulse signal to the preamplifier unit. The preamplifier unit amplifies the signal and sends to the amplifier unit. The amplifier unit performs secondary amplification and sends the amplified signal to the frequency discrimination amplifier unit. The frequency discrimination amplifier unit further amplifies the signal, performs phase discrimination, and forms a continuous positive pulse signal to send to terminal 2.3 of the integrated circuit block IC of the processing control unit. After being processed by the integrated circuit block IC, the signal is sent to the lift arm actuating unit, which in turn controls the motor to rotate clockwise/counterclockwise. In addition, the processing control unit controls the speaker Y to make a series of “ding ding”,and/or train passing sounds via the sound actuating unit. At the same time, the processing control unit also controls the alarm lights to make them flash alternately via the alarm-lights actuating unit, so as to indicate that a train is passing through, and the processing control unit will play the sound of the train passing.

The integrated circuit block IC has three language modes:
Mode 1 is English
Mode 2 is French
Mode 3 is Spanish

The three language modes can be interchanged at any times.

When switching the wave band interchanging switch to mode 1, mode 2 or mode 3, “ding ding” sound is played.

After the IC has been powered on for approx ten seconds, the inductive indicator (green LED) turns on.

When the switch is turned to mode 1 (English mode), a “ding ding” sound is played (only once), and P1 has high electric level output until K1 is closed. When the green LED is on, if a person is detected and thus triggers the IC (if no signal is detected for one minute, IC will switch to ‘sleep mode’ automatically; and it can be re-activated by switching on the power), the following sound will be played (green LED turns off after detecting the signal).
(a) “The train is crossing! Stay clear of the tracks”→the sound “ding ding”→train passing sound→P2 has high electric level output until K2 is closed;
(b) The train is approaching! Prepare to stop!→the sound “ding ding” train passing sound→P2 has high electric level output until K2 is closed.
(c) Here comes the train!→the sound “ding ding”→train passing sound→P2 has high electric level output until K2 is closed.

(Alternately selecting one of the above phrases with continuous “ding ding” sound, and with the two alarm indicator lights flashing alternately at a frequency of 2 Hz when in high electric level output)
(a) “The train has passed! You are clear to go↓→sound “ding ding”+vehicle acceleration sound→P1 has high electric level output until K1 is closed.
(b) Railroad crossing! Please use caution!→“ding ding” sound→vehicle acceleration sound→P1 has high electric level output until K1 is closed.
(c) the train has passed! Proceed with caution!→“ding ding” sound→vehicle acceleration sound→P1 has high electric level output until K1 is closed.

When the switch is turned to mode 2(French), a “ding ding” sound is produced (only once), and P1 has high electric level output until K1 is closed. When the green LED is on, if a person is detected and thus triggers IC (if no signal is detected for one minute, IC will switch to ‘sleep mode’ automatically, and it can only be re-activated by switching on the power), the following sound will be produced (green LED turns off after the detecting the signal):
(a) “Le train passera! Ecarte-toi des rails!”→“ding ding” sound→train passing sound→P2 has high electric level output until K2 is closed.
(b) “Le train approche! Apprête-toi à t'arreter!→“ding ding” sound→train passing sound→P2 has high electric level output until K2 is closed.
(c) voici the train qui arrive!→“ding ding” sound→train passing sound→P2 has high electric output until K2 is closed.

(Alternately selecting one of the above phrases with continuous “ding ding” sound, and with the two alarm indicator lights flashing alternately at a frequency of 2 Hz when in high electric level output).
(a) “Le train est passé! La route est libre!→“ding ding” sound vehicle acceleration sound→P1 has high electric level output until K1 is closed.
(b) “Passage à niveau! Sois prudent!→“ding ding” sound→vehicle acceleration sound→P1 has high electric level output until K1 is closed.
(c) Le train est passé. Avarice avee prudence!→“ding ding” sound→vehicle acceleration sound→P1 has high electric level output until K1 is closed.

(Alternately selecting one of the above phrases with continuous “ding ding” sound, and with the two alarm indicator lights flashing alternately at a frequency of 2 Hz when in high electric level output).

When the switch is turned to mode 3 (Spanish), the sound “ding ding” will be, produced (only once), P1 has high electric level output until K1 is closed.

When the green LED is on, if a person is detected and thus triggers IC (if no signal is detected for one minute, IC will switch to ‘sleep mode’ automatically, and it can only be re-activated by switching on the power), the following sound will be produced (green LED turns off after the detecting the signal):
(a) I EI tren esta à cruzando! I Permanece le jos de las vias!→“ding ding” sound→train passing sound→P2 has high electric level output until K2 is closed.
(b) I EI tren se acerca! I preparate para parar!→“ding ding” sound→train passing sound→P2 has high electric level output until K2 is closed.
(c) I Ahora llegael tren!→“ding ding” sound→train passing sound→P2 has high electric level output until K2 is closed.

(Alternately selecting one of the above phrases with continuous “ding ding” sound, and with the two alarm indicator lights flashing alternately at a frequency of 2 Hz when in high electric level output).
(a) “I EI tren se ha marchado! i Ya puedes pasar'!→“ding ding” sound→vehicle acceleration sound→P1 has high electric level output until K1 is closed.
(b) i Paso a nivel! i Precaucion!→“ding ding” sound→vehicle acceleration sound→P1 has high electric output until K1 is closed.
(c) i tren se ha marchado! i Continua con precaution!→“ding ding” sound→vehicle acceleration sound→P1 has high electric level output until K1 is closed.

### Embodiment 5

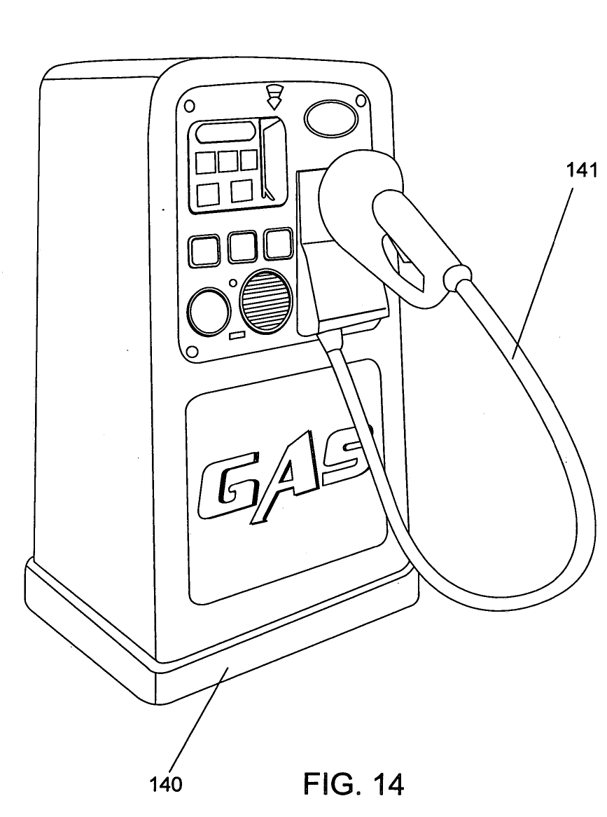

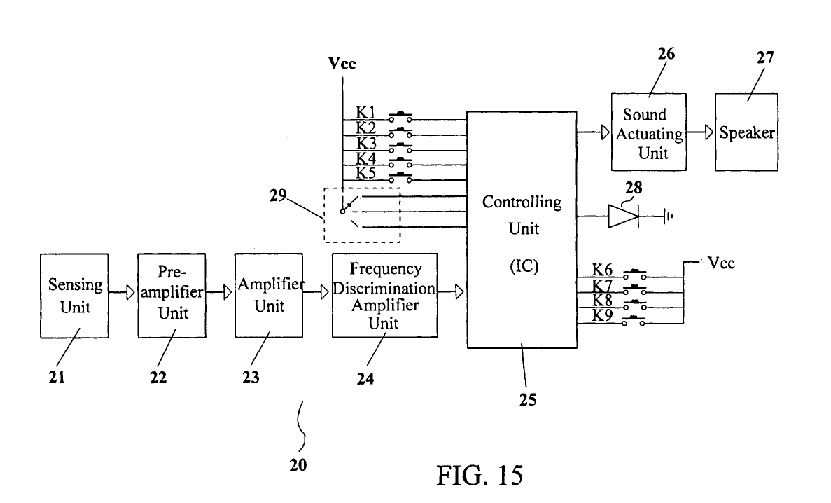

Please refer to FIG. 14 and FIG. 15, the photoelectric: controller 20 of the present invention is provided in a demonstrating apparatus that simulates a gas pump. The demonstrating apparatus includes a control box 140 and an oil gun 141. The control box 140 has a control panel, and the oil gun 141 is connected to the control box 140 via a flow line. The photoelectric controller 20 is mounted in the control box 140. The demonstrating apparatus further includes an oil grade control unit (formed by K1, K2, K3), a payment control unit (formed by K4, K5, K6), and a confirmation unit for confirming (formed by K7, K8) and card inserting (K9).

The processing control unit 25 may have built-in programs for controlling language mode interchanging and sound simulating.

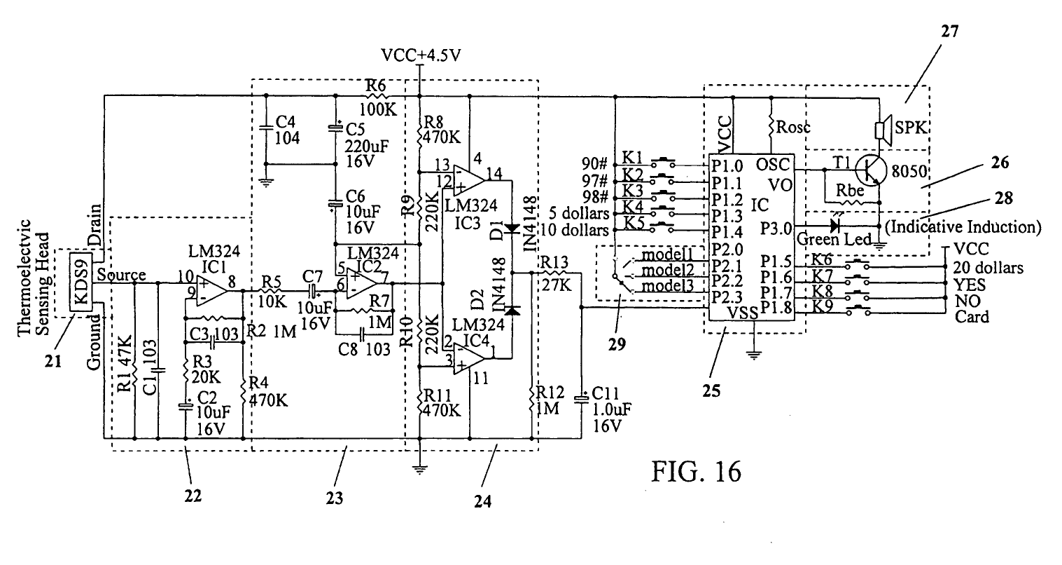

In the following, the demonstrating apparatus will be further described with reference to FIG. 16.

In FIG. 16, the sensing unit is a KDS9 type thermoelectric detector, the output of which is connected to the input end of the preamplifier unit. The preamplifier unit is an operational amplifier, in which R1, C1 form a filter, and C3, C2, R4 form a “Π” type filter. The output of the preamplifier unit is connected to the input of the amplifier unit. The amplifier unit is also an operational amplifier. The output of the amplifier unit .is connected to the input of the frequency discrimination amplifier unit. The frequency discrimination amplifier unit adopts two operational amplifiers and two diodes. The output of the frequency discrimination amplifier unit is connected to-the input of the processing control unit. The preamplifier unit, the amplifier unit, and the frequency discrimination amplifier unit can share a LM324 type 4-operational amplifier. The processing control unit is a special integrated block IC. The language mode interchanging unit adopts a 3-wave-band switch BK corresponding to three language modes. Terminals P2.1, P2.2, P2.3 of the integrated circuit block IC are connected to the wave band switch BK respectively. Switches K1, K2, K3 form an oil grade control unit, K1 corresponds to “diesel”, K2 corresponds to “unleaded”, and K3 corresponds to “super-unleaded”. K1, K2, K3 are respectively connected to-terminals P1.0, P1.1, P1.2 of the integrated circuit block IC. Switches K4, K5, K6 form a payment control unit, K4 corresponds to “5”, K5 corresponds to “10”, and K6 corresponds to “20”. Switches K7, K8, K9 form a confirmation unit, in which K7 corresponds to ‘yes’, K8 corresponds to “no”, and K9 corresponds to card insertion (card swiping sounds). The above-mentioned switches K1, K2, K3, K4, K5, K6, K7, K8, K9 are respectively connected to the terminals P1.0, P1.1, P1.2, P1.3, P1.4, P1.5, P1.6, P1.7, P1.8 of the integrated circuit block IC. Terminal P2.3 is an input terminal which receives the output signal from the frequency discrimination amplifier unit. Vcc is connected to the positive pole of a power supply. OSC is connected to the positive pole of the power supply via a resistor. Vss in earthed. Terminal V_{O} is connected to the input end of the sound actuating unit, which is a triode T1. The speaker SPK is connected between the collector of T1 and Vcc. Terminal 3.0 is connected to the inductive indicator which is green LED (light-emitting-diode).

When a person approaches the demonstrating apparatus within a certain range (normally the distance is set to about 3 meters with a viewing angle of 130°), the thermoelectric detector detects the infrared rays emitted by the human body, and sends a pulse signal to the preamplifier unit for preliminary amplification. The preamplifier unit preliminarily amplifies the signal and sends the signal to the amplifier unit. The amplifier unit performs secondary amplification and sends the amplified signal to the frequency discrimination amplifier unit. The frequency discrimination amplifier unit further amplifies the signal and performs phase discrimination, so as to form a continuous positive pulse signal which is then sent to terminal P2.3 of the integrated circuit block IC of the processing control unit for processing. The processing control unit controls the sound actuating unit to drive the speaker SPK to play sounds, so as to indicate people to select the oil grade, the payment amount, the confirmation key, and to insert the card. Various simulating sounds can be played according to various situations.

The integrated circuit block IC has the following 3 operation modes, among them:
Mode 1 is in English language
Mode 2 is in French language
Mode 3 is in Spanish language

Mode 1, Mode 2 and Mode 3 can be interchanged at any time.

When the wave band switch is switched to Mode 1, Mode 2 or Mode 3, a “ding ding” sound is played. After the integrated circuit block IC has been powered on for 10 second, the green LED turns on.

Mode 1 (English)

5.1) If a person walks into the detectable area when the green LED is on, (the green LED turns off after detecting a signal, and will turn on again when waiting for signal), the following sound is played: gas station sound “ding-ding” (ring of bell), “Hi! Get your fuel here and fill'er up!”.

5.2) Then, the following sound will be heard: “please select the type of fuel, diesel, unleaded, or supe; unleaded!”

If K1, K2 or K3 is selected, the sound “thank you” will be produced. If no selection is made, the sound of step 5.2) will be repeated every 5 seconds for three times, and then goes to step 5.1) waiting for signal.

If one of K1, K2 or K3 is selected, the sound of “Please select the amount. 5, 10 or 20!” will be played. If no selection is made, the above sound will be repeated every five seconds for 3 times, and then goes to a waiting state.

If correct, then press “YES” button (K7) (if incorrect, then press “NO” button (K8)), the sound “Please insert your card for payment” will be produced. After the card is inserted a card insertion sound is played “Your transaction is being processed, please wait!” “Thank you! And don't forget your card.”

If the gas pump switch (K9) is closed, the following sound will be played: “remove the handle and fill'er up! Don't spill the fuel!→gas pumping sound when the nozzle pressed→“Your tank is full! Thank you and come again soon!”→gas station sound (If no gas is pumped, the above sound will be repeated every five seconds for 3 times, and then goes to a waiting state.)

Mode 2 (French)

6.1) If a person walks into the detectable area when the green LED is on, (the green LED turns off after detecting a signal, and will turn on again when waiting for signal) “ding-ding”, the following sound is played: “hallo! Prends de l'essence ici et fais le plein!”.

6.2) After the gas station sound, the following sound will be heard “Choisis de type d'essence: ordinaire, sans plomb ou super sans plomb!”

If K1, K2 or K3 is selected, the sound of “Mesei” will be produced. If no selection is made, the sound of step 6.2) will be repeated every five seconds for three times.

If one of K1, K2 or K3 is made, the sound of “sélectionne le montant: 5.10 ou 20!” will be produced. If no selection is made, the above sound will be repeated every 5 seconds for 3 times, it then goes to a waiting state.

If correct, then press “YES”button (K7) (if incorrect, then press “NO”button (K8)), the sound “S'il te plait, insère ta carte pour payer.” will be played. After the card is inserted a card insertion sound will be produced→Ta transaction est en cours, s'il te plait!”→Merci! Et n'oublie pas de reprendre ta carte.

If the gas pump switch (K9) is closed, the following sound will be played: “Décroche le bras de pompe et fais le plein! Attention de ne pas sep andre de l'essence!→gas pumping sound when the nozzle pressed→Ton reservoir est plein, Mesci et seviens bientôt!→gas station sound.

Mode 3 (Spanish)

7.1) If a person walks into the detectable area when the green LED is on, (the green LED turns off after detecting a signal, and will turn on again when waiting for a signal) the following sound is played: “iHola! i Adquiere tu gasoline aqui y Ilena aqui y llena el depó sito”→Aseqù rate de apagar el motor→gas station sound

7.2) After the gas station sound, the following sound will be heard: “i Selecciona el tipo de gasoline, Normal, sin plomo ó super sin plomo!”.

If K1, K2 or K3 has been selected, the sound of “Gracias!” will be produced. If no selection is made, the sound of step 7.2) will be. repeated every five seconds for 3 times, and then goes to step 7.1) waiting for signal.

If one of K1, K2 or K3 is selected, the sound of “i Selecciona la cantidad: 5.10, ó 20!” will be-played. If no selection is made, the above sound will be repeated every five seconds for 3 times, and then goes to a waiting state.

If correct, then press “YES” button (K7) (if incorrect, then press “NO” button (K8)), the sound of “Introduce tu taijeta para efectuar el pago” will be produced. (if no card has been inserted, the sound will be repeated every 5 seconds for 3 times and then goes to a waiting state). When the card has been inserted, the sound of “Tu operació n se est à realizando, espera por favor!→i Gracias! Y no olvides tu tarjeta.” will be produced.

If the gas pump switch (K9) is closed, the following sound will be played: “i Agarra la manguera Y Ilena el depó sito!” i No derrames la Gasolina!→gas pumping sound ‘Tu depo sito esta lieno! Graci as y hasta pronto!’→gas station sound. (If no gas is pumped, the above sound will be repeated every five seconds for 3 times, and then goes to a waiting state.)

It is understood that the language modes, the oil grade, the payment amount are not limited to the range of the above mentioned ones.

1. A photoelectric controller installed in a demonstrating apparatus, including:
a sensing unit for detecting a signal of a body motion;
a preamplifier unit receiving the signal from the sensing unit and performing primary amplification;
an amplifier unit receiving the signal from the preamplifier unit and performing secondary amplification;
a frequency discrimination amplifier unit receiving the signal from the amplifier unit, and performing a fuirther amplification and phase discrimination;
a processing control unit receiving the signal from the frequency discrimination amplifier unit, and performing processing;
a sound actuating unit receiving the signal from the processing control unit to actuate a speaker:

2. The photoelectric controller according to claim 1, wherein the sensing unit is a thermoelectric detector.

3. The photoelectric controller according to claim 1, wherein the photoelectric controller further includes a language mode interchanging unit having a wave band interchanging switch,
the wave band interchanging switch having one end connecting to a power supply and the other end having a plurality of terminals each of which connects to the processing control unit.

4. The photoelectric controller according to claim 1, wherein a filter is provided between the preamplifier unit and the sensing unit, and a ‘Π’ type filter is provided between the input and the output of the preamplifier unit; and wherein the preamplifier unit and the amplifier unit are both operational amplifiers.

5. The photoelectric controller according to claim 1, wherein the photoelectric controller further includes an inductive indicator, which is connected between the processing control unit and the earth.

6. The photoelectric controller according to claim 1, wherein the processing control unit has built-in programs for controlling language mode interchanging and sound simulating.

7. A demonstrating apparatus simulating the real life-traffic lights system built in the photoelectric controller, wherein, the demonstrating apparatus further including a lamp case having three indicator lights, a red light, a yellow light and a green light, and
an indicator-lights driving unit having three branch circuits, the indicator-lights driving unit connecting to the processing control unit to receive an output signal, so as to control the three indicator lights to turn on alternately;
the photoelectric controller is installed in the lamp case.

8. The demonstrating apparatus of claim 7, wherein the processing control unit has built-in programs for controlling the three. indicator-lights to turn on alternately, language mode interchanging and sound simulating.

9. The demonstrating apparatus of claim 7, wherein the lamp case is installed on a support pole with a base there under, and wherein the sensing unit is mounted on the front face of the lamp case.

10. The demonstrating apparatus simulating a road sign built in the photoelectric controller, wherein, the demonstrating apparatus further including a plurality of signboards which can be exchanged,
a bracket for holding the signboard,
a stand for supporting the bracket with a-base there under,
a plurality of operation switches connecting to the processing control unit, the operation switches corresponding to various road signs;
the photoelectric controller is installed in the bracket.

11. The demonstrating apparatus simulating a parking meter built in the photoelectric controller, the demonstrating apparatus further including a meter head having an operation panel, a time indication light, and coin dropping/card inserting slots;
a stand holding the meter head; and
a time & fee control unit connected between a power supply and the processing control unit, the time & fee control unit confirming parking time and payment method;
the photoelectric controller is installed in the meter head.

12. The demonstrating apparatus of claim 11, wherein the processing control unit has built-in programs for time counting, fee calculating, language mode interchanging, and sound simulating.

13. The demonstrating apparatus of claim 11, wherein the demonstrating apparatus further includes a parking time & payment method display unit, which indicates parking time and payment method,
the parking time & payment method display unit being connected between the processing control unit and the earth.

14. The demonstrating apparatus simulating a railroad crossing built in the photoelectric controller; the demonstrating apparatus further including a crossing bar having a lift arm, a case, and a stand for supporting the lift arm and the case; and
a lift arm actuating unit connecting to the processing control unit to receive an output signal, so as to actuate a motor to raise/drop the lift arm;
the photoelectric controller is installed in the case.

15. The demonstrating apparatus of claim 14, wherein the processing control unit has built-in programs for alternate arm raising/dropping, language mode interchanging and sound simulating.

16. The demonstrating apparatus of claim 14, wherein the lift arm actuating unit contains an arm-raising actuating branch and an arm-dropping actuating branch,
the arm-raising actuating branch driving the motor to rotate clockwise, and the arm-dropping actuating branch driving the motor to rotate counterclockwise.

17. The demonstrating apparatus of claim 14, wherein the demonstrating apparatus further includes an alarm-lights actuating unit and two alarm lights;
the alarm-lights actuating unit connecting to the processing control unit to receive an output signal, the alarm-lights actuating unit having two actuating branches to respectively actuate the two alarm lights, so as to control the two alarm lights to turn on alternately.

18. The demonstrating apparatus of claim 14, wherein the sensing unit is mounted on the front of the case, and the stand has a cross-shaped signboard mounted thereon.

19. The demonstrating apparatus simulating a gas pump built in the photoelectric controller, the demonstrating apparatus including a control box having control panel,
an oil guri connected to the control box via a flow line,
an oil grade control unit confirming the oil grade,
a payment control unit confirming payment amount, and
a confirmation unit confirming money transaction;
the oil grade control unit, the payment control unit, and the confirmation unit are connected between the processing control unit and a power supply,
the photoelectric controller is installed in the control box.
